(19) United States
(12) Patent Application Publication
(10) Pub. No.: US 2025/0091684 A1
(43) Pub. Date: Mar. 20, 2025

(54) SADDLE-TYPE ELECTRIC VEHICLE

(71) Applicant: HONDA MOTOR CO., LTD., Tokyo (JP)

(72) Inventors: Masayuki Kinoshita, Tokyo (JP); Yuji Noguchi, Tokyo (JP); Tomoya Matsuo, Tokyo (JP); Susumu Hayashihara, Tokyo (JP)

(21) Appl. No.: 18/885,795

(22) Filed: Sep. 16, 2024

(30) Foreign Application Priority Data
Sep. 19, 2023 (JP) 2023-151739

(51) Int. Cl. B62K 11/02; B62J 43/16

(52) U.S. Cl. CPC B62K 11/02; B62J 43/16; B62K 2204/00

(57) ABSTRACT

An electric motorcycle includes: a head pipe; a pair of left and right main frames; and a battery unit disposed between the left and right main frames behind the head pipe, in which each main frame includes an extending portion extending along a vehicle front-rear direction in a plan view, and a front curved portion extending forward of the extending portion so as to curve inward in a vehicle width direction in the plan view, and having a front end portion connected to the head pipe, and the front curved portion extends forward of the extending portion so as to curve upward in a side view.

### CROSS-REFERENCE TO RELATED APPLICATION

Priority is claimed on Japanese Patent Application No. 2023-151739, filed in Japan on Sep. 19, 2023, the entire content of which is incorporated herein by reference.

### BACKGROUND OF THE INVENTION

### Field of the Invention

The present invention relates to a saddle-type electric vehicle.

### Description of Related Art

A conventional vehicle body frame structure for a motorcycle includes a head pipe that supports a steered wheel, and a pair of left and right main frames (upper frames) that extend rearward so as to branch to the left and right from the head pipe, the left and right main frames being bent upward toward the head pipe in a side view (see, for example, Patent Document 1 below). Each main frame is inclined inward in the vehicle width direction and connected to the head pipe in front of a bent portion bent upward as described above. Various accessories such as an air cleaner and electric components are disposed between the left and right main frames.
[Patent Document 1] Japanese Patent No. 6248209

### SUMMARY OF THE INVENTION

In recent years, electrification of saddle-type electric vehicles such as motorcycles has progressed. In a saddle-type electric vehicle including an electric motorcycle, a vehicle driving battery (storage battery) may be mounted between the left and right main frames. In such a constitution, the battery is inserted and removed from above between the left and right main frames. Thus, it is desired to improve the ease of insertion and removal of the battery while maintaining the package as a completed vehicle without reducing the outer shape of the battery.

An aspect according to the present invention has been made in view of the above problems, and an object thereof is to facilitate insertion and removal of a vehicle driving storage battery between left and right upper frames without reducing the storage battery in a saddle-type electric vehicle in which the storage battery is mounted between the left and right upper frames.

In order to solve the above problem and achieve the object, the present invention employs the aspects described below.

(1) A saddle-type electric vehicle according to one aspect of the present invention includes: a head pipe supporting a steered wheel; a pair of left and right upper frames extending rearward from the head pipe so as to branch leftward and rightward; and a vehicle driving storage battery disposed between the pair of left and right upper frames behind the head pipe, in which each of the upper frames includes an extending portion extending along a vehicle front-rear direction in a plan view, and a front curved portion extending forward of the extending portion so as to curve inward in a vehicle width direction in the plan view, and having a front end portion connected to the head pipe, and the front curved portion extends forward of the extending portion so as to curve upward in a side view.

With this constitution, the front curved portion of each upper frame curved inward in the vehicle width direction in a plan view is curved upward also in a side view. Thus, the position of each upper frame is lowered downward with respect to the head pipe as a whole, and the range of the storage battery protruding upward from each upper frame increases. Then, even in the constitution in which the storage battery is inserted and removed from above between the left and right upper frames, an upper portion of the storage battery is easily held, and the range of the storage battery passing between the left and right upper frames is reduced. Thus, the workability of inserting and removing the storage battery can be improved without affecting the capacity of the storage battery. The lower position of the upper frame improves the degree of freedom of arrangement of the legs of the occupant. For example, when the saddle-type electric vehicle is an off-road vehicle, the upper frame can be made less likely to be an obstacle even at the time of cornering in which the leg on the turning side is extended forward. Furthermore, in a case where warm air is confined in the case due to a weather environment or the like, the warm air moves to an upper portion of the case, so that the cooling performance is improved as the exposure on the upper side increases.

(2) In the above aspect (1), the front curved portion may have a cross-sectional shape that is long in an up-down direction, and the front curved portion may be formed by being twisted so that a cross-sectional longitudinal direction, which is a longitudinal direction of the cross-sectional shape, approaches a vertical direction in the side view as approaching the head pipe side from the extending portion side.

With this constitution, the front curved portion is formed by being twisted so that the cross-sectional longitudinal direction approaches the vertical direction as the front curved portion approaches the head pipe, whereby the cross-sectional shape of the front curved portion can be prevented from falling backward and narrowing the space between the left and right upper frames near the head pipe.

The front curved portion is formed by being twisted so that the cross-sectional longitudinal direction approaches the vertical direction as approaching the head pipe, whereby the inner wall near the front end of the front curved portion can be made along the insertion and removal direction of the storage battery. Thus, a clearance at the time of insertion and removal of the storage battery can be easily ensured near the front end of the front curved portion, and the insertion and removal workability of the storage battery can be improved without affecting the outer shape (eventually, the capacity) of the storage battery.

(3) In the above aspect (1) or (2), the storage battery may include a rectangular parallelepiped box portion overlapping each of the upper frames in the side view, and the box portion may protrude upward and downward of each of the upper frames in the side view, and each of the upper frames may be disposed outside in the vehicle width direction at a center position of the box portion in the side view.

With this constitution, by disposing the upper frame on the outer side in the vehicle width direction of the center position of the rectangular parallelepiped box portion, the vicinity of the center of the box-shaped object having relatively low strength can be protected by the upper frame from the outer side in the vehicle width direction.

Although hot air tends to be confined upward inside the storage battery, since an upper portion of the box portion protrudes upward from the upper frame, the upper frame does not hinder heat dissipation from the upper portion of the box portion, cooling performance of the upper portion of the storage battery can be improved.

(4) In any one of the above aspects (1) to (3), the front curved portion of the upper frame on a front side of a front-rear center may be gradually inclined upward in the side view, and the front curved portion may be gradually inclined toward a center in the vehicle width direction in a top view.

With this constitution, since a bending point is not provided in the front curved portion of the upper frame, flexibility in setting strength rigidity of the upper frame can be improved.

(5) In any one of the above aspects (1) to (4), a shroud may be provided so as to straddle the upper frame from a front side to a rear side in a side view.

With this constitution, by providing the shroud that straddles the upper frame in the front-rear direction, the upper frame is positioned lower than usual, so that the position of the shroud can be lowered and downsizing can be achieved.

According to an aspect of the present invention, it is possible to facilitate insertion and removal of a vehicle driving storage battery between left and right upper frames without reducing the storage battery in a saddle-type electric vehicle in which the storage battery is mounted between the left and right upper frames.

### BRIEF DESCRIPTION OF THE DRAWINGS

FIG. 1 is a left side view of an electric motorcycle (saddle-type electric vehicle) according to an embodiment of the present invention;

FIG. 2 is a left side view of a substantial part of the above electric motorcycle;

FIG. 3 is a plan view (top view) of the substantial part of the above electric motorcycle;

FIG. 4 is a perspective view of a battery unit of the above electric motorcycle;

FIG. 5 is a left side view illustrating an inside of the above battery unit;

FIG. 6A is a left side view of a front portion of a vehicle body frame of the above electric motorcycle;

FIG. 6B is a cross-sectional view taken along line B-B of FIG. 6A;

FIG. 7 is a rear view of a front portion of the vehicle body frame; and

FIG. 8 is a left side view illustrating a comparative example of a front end portion of a front curved portion of the vehicle body frame.

### DETAILED DESCRIPTION OF THE INVENTION

Hereinafter, an embodiment of the present invention will be described with reference to the drawings. In the following description, directions of front, rear, upper, lower, left, and right are the same as directions in a vehicle to be described below. That is, an up-down direction coincides with a vertical direction, and a left-right direction coincides with a vehicle width direction. In the vehicle width direction, a direction away from the vehicle width center will be referred to as an outer side in the vehicle width direction, and a direction approaching the vehicle width center will be referred to as an inner side in the vehicle width direction. In the drawings to be used in the following description, an arrow UP indicates upward, an arrow FR indicates forward, and an arrow LH indicates leftward. A line CL in the drawings indicates a center line in the vehicle width direction (vehicle width center).

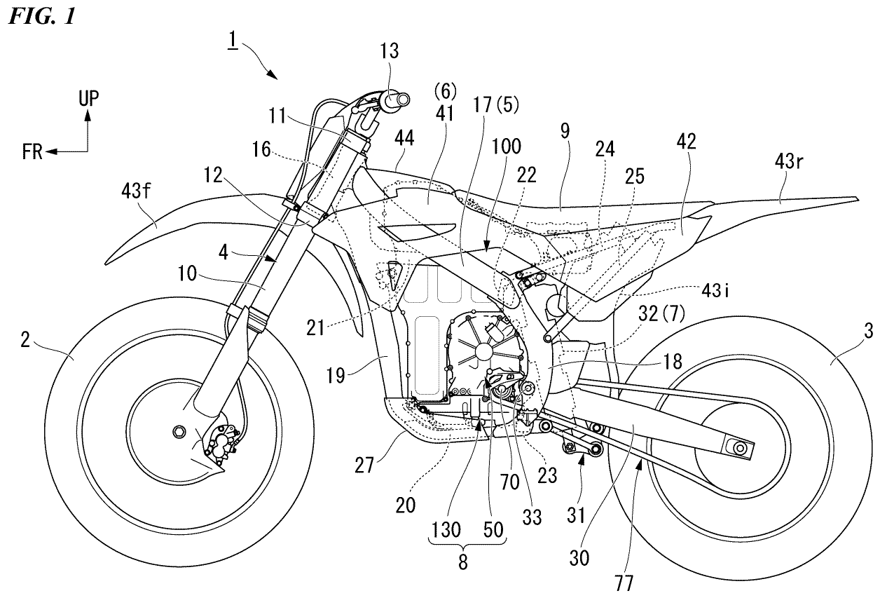

FIG. 1 is a left side view of an electric motorcycle (saddle-type electric vehicle) 1 according to one embodiment.

As illustrated in FIG. 1, the electric motorcycle 1 in one embodiment is a saddle-type electric vehicle of an off-load type. In the electric motorcycle 1, an up-down stroke amount of the wheel is largely ensured, a ground height of the vehicle body is largely ensured, and the vehicle body is downsized and light-weighted to concentrate the mass of the vehicle body.

The electric motorcycle 1 includes a front wheel 2, a rear wheel 3, a front wheel suspension system 4, a vehicle body frame 5, a vehicle body cover 6, a rear wheel suspension system 7, a power unit 8, and a battery unit 100.

The front wheel suspension system 4 includes: a pair of left and right front forks 10, which pivotally support the front wheel 2 at lower end portions; a top bridge 11 and a bottom bridge 12, which are provided between upper parts of the pair of front forks 10; and a stem pipe (not illustrated) provided between the top bridge 11 and the bottom bridge 12 and inserted into a head pipe 16. The front wheel 2 is supported to be steerable by the head pipe 16 of the vehicle body frame 5 via the front wheel suspension system 4. A steering handlebar 13 is supported on the top bridge 11. In the embodiment, the front forks 10 of a telescopic type are exemplified as a front suspension of the electric motorcycle 1, without being limited to this constitution. For example, the front suspension may be of another type such as a link type using a swing arm.

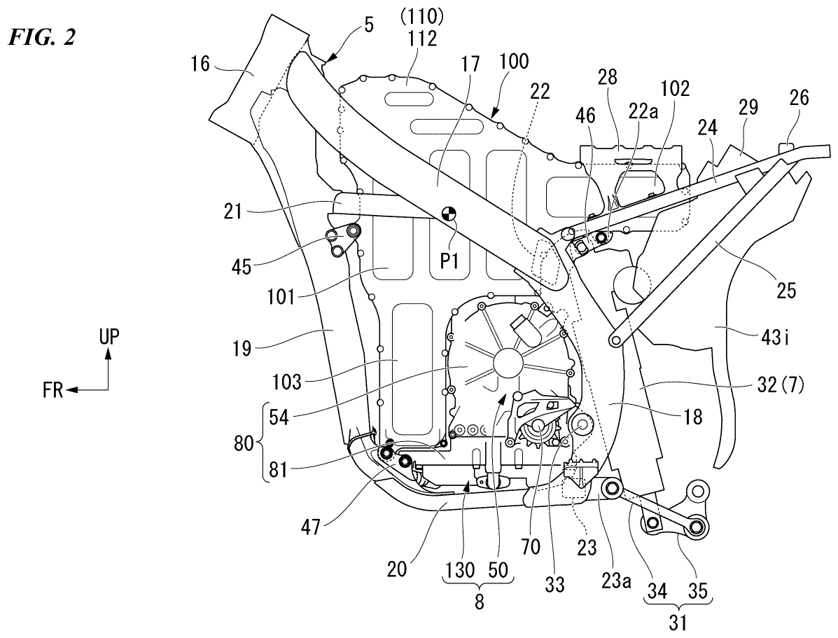

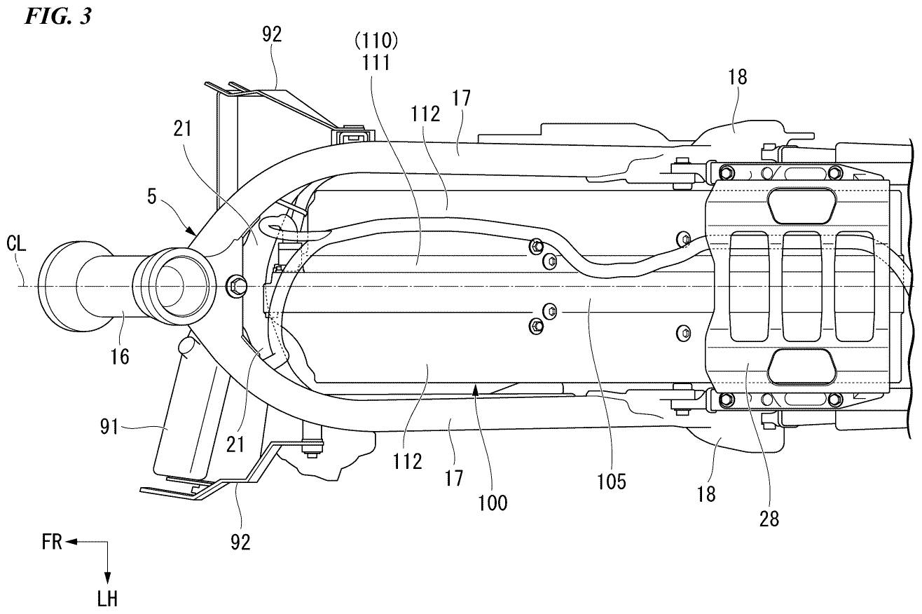

FIG. 2 is a left side view of a substantial part of the electric motorcycle 1, and FIG. 3 is a plan view (top view) of the substantial part of the electric motorcycle 1.

As illustrated in FIGS. 1 to 3, the vehicle body frame 5 includes the head pipe 16, a pair of left and right main frames 17, a pair of left and right pivot frames 18, a down frame 19 as a single part, a pair of left and right lower frames 20, a gusset pipe 21, which connects the left and right main frames 17 with the down frame 19, a cross member 22, and a lower cross member 23. They are integrally coupled by welding or the like. Hereinafter, an assembly in which these frame members are integrated not to be dividable will be referred to as a “frame main body”.

The head pipe 16 is positioned on a vehicle width center CL, and is provided as a single part on a front end of the vehicle body frame 5. The head pipe 16 is supported to be rotatable with the stem pipe inserted into the head pipe 16.

The pair of main frames 17 branch to the left and right from an upper portion of the head pipe 16, and extend rearward and downward. The pair of main frames 17 are coupled with each other in their respective front end portions. Front portions of the pair of main frames 17 extend while being curved to bulge outward in the vehicle width direction on a rear side of the head pipe 16, in a plan view when viewed from above. Rear portions of the pair of main frames 17 linearly extend along the front-rear direction, in the plan view when viewed from above.

The pair of pivot frames 18 extend rearward and downward respectively from rear end portions of the main frames 17 on the same left and right sides. The pair of pivot frames 18 are each curved, and extend to form an arc shape convex rearward in a side view. A pivot shaft 33, which extends in the vehicle width direction, is bridged between intermediate portions of the pair of pivot frames 18 on a lower side in the up-down direction. The term “intermediate” used in one embodiment includes not only the center between both ends of an object but also an inner range between both ends of the object.

The down frame 19 extends rearward and downward from a lower portion of the head pipe 16. The down frames 19 extend rearward and downward to be steeper than the main frames 17 in a side view. A radiator 91 for cooling the power unit 8 is attached to at least one of left and right side portions (a left side portion in one embodiment) of the down frame 19.

The pair of lower frames 20 branch to the left and the right from a lower end portion of the down frame 19, and extend rearward. Rear end portions of the pair of lower frames 20 are respectively coupled with lower end portions of the pivot frames 18 on the same left and right sides.

Left and right side portions of the gusset pipe 21 couple the main frames 17 with the down frames 19 on the same left and right sides. The gusset pipe 21 branches to the left and the right from an intermediate portion of the down frame 19 on an upper side in the up-down direction, and extend rearward. Rear end portions of the gusset pipe 21 are respectively coupled with intermediate portions in the front-rear direction of the main frames 17 on the same left and right sides.

The cross member 22 extends in the vehicle width direction, and couples rear portions of the pair of main frames 17 (or upper portions of the pair of pivot frames 18). A cushion support bracket 22a, which extends rearward and upward, are fixed on an inner side in the vehicle width direction of the cross member 22. An upper end portion of the rear cushion 32 and the battery unit 100 are coupled with the cushion support bracket 22a.

The lower cross member 23 extends in the vehicle width direction, and couples lower portions of the pair of pivot frames 18 on a lower side than the pivot shaft 33. A link support bracket 23a, which extends rearward, is fixedly provided on an inner side in the vehicle width direction of the lower cross member 23. A front end portion of a link arm 34 is coupled with the link support bracket 23a.

The vehicle body frame 5 further includes a pair of left and right seat rails 24, and a pair of left and right support rails 25. Front end portions of the left and right seat rails 24 are respectively coupled with upper end portions of the pivot frames 18 on the same left and right sides. Each of the left and right seat rails 24 extends rearward and upward from the front end portion. A seat 9 is disposed above the left and right seat rails 24. Front-rear intermediate portions of the left and right seat rails 24 are coupled with each other via a seat receiving bracket 28, which receives the load from the seat 9.

The left and right support rails 25 are positioned below the left and right seat rails 24. Front end portions of the left and right support rails 25 are respectively coupled with up-down intermediate portions of the pivot frames 18 on the same left and right sides. Each of the left and right support rails 25 extends rearward and upward from the front end portion. Rear end portions of the left and right support rails 25 are respectively coupled with the rear portions of the left and right seat rails 24 from below on the same left and right sides.

Rear portions of the left and right seat rails 24 are coupled with each other by a cross rail 26, which extends in the vehicle width direction. The pair of left and right seat rails 24, the pair of left and right support rails 25, and the cross rail 26 are integrally coupled by welding or the like. Hereinafter, an assembly in which these frame members are integrated not to be dividable will be referred to as a sub frame detachably attached to the frame main body. The sub frame corresponds to a seat frame that supports the seat 9 from below.

The vehicle body frame 5 is of a semi-double cradle type. In the vehicle body frame 5, the power unit 8 including a motor 50 is mounted below the rear portions of the left and right main frames 17 on a rear side of the head pipe 16 and on a front side of the left and right pivot frames 18. The vehicle body frame 5 surrounds the power unit 8 with the down frame 19 as a single part and the left and right lower frames 20 from the front side and the lower side.

Inside the vehicle body frame 5, the power unit 8 for the traveling of the vehicle is mounted, and in addition, the battery unit 100, which stores electric power to be supplied to the power unit 8, is mounted. The vehicle body frame 5 enables the battery unit 100 to be inserted and removed from above through an opening between the left and right main frames 17. Front portions of the left and right main frames 17 and the gusset pipe 21 each have a large curvature outward in the vehicle width direction in order to ensure a clearance with respect to the front portion of the battery unit 100.

The vehicle body cover 6 covers the vehicle body frame 5 and the like. The vehicle body cover 6 includes a pair of left and right front side cowls 41 and a pair of left and right rear side cowls 42.

The pair of front side cowls 41 are respectively disposed from lower positions on both left and right sides of the front portion of the seat 9 to positions that overlap an upper portion of the down frame 19, in a side view when viewed from the vehicle width direction. Each of the front side cowls 41 extends to be broader in a side view from below a front portion of the seat 9 toward the front side. The front side cowls 41 respectively extend in the front-rear direction to traverse the outside in the vehicle width direction of the main frames 17 on the same left and right sides. At least one of the front side cowls 41 functions as an air guide plate (radiator shroud) for the radiator 91, which is supported by a side portion of the down frame 19.

The pair of rear side cowls 42 are disposed in positions below the seat 9 on both left and right sides in a rear part of the seat 9 in a side view. The rear side cowls 42 are respectively disposed to cover the seat rail 24 and the support rail 25 on the same left and right sides from the outside in the vehicle width direction.

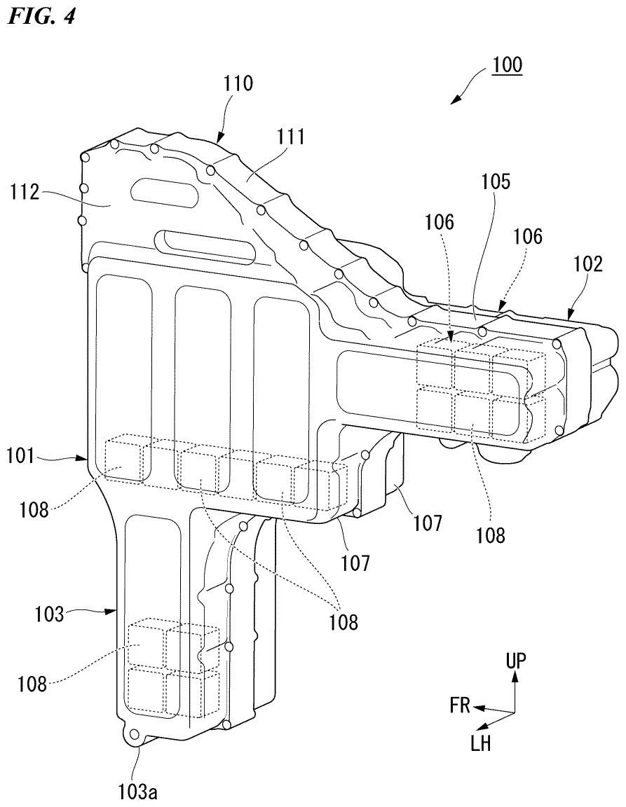

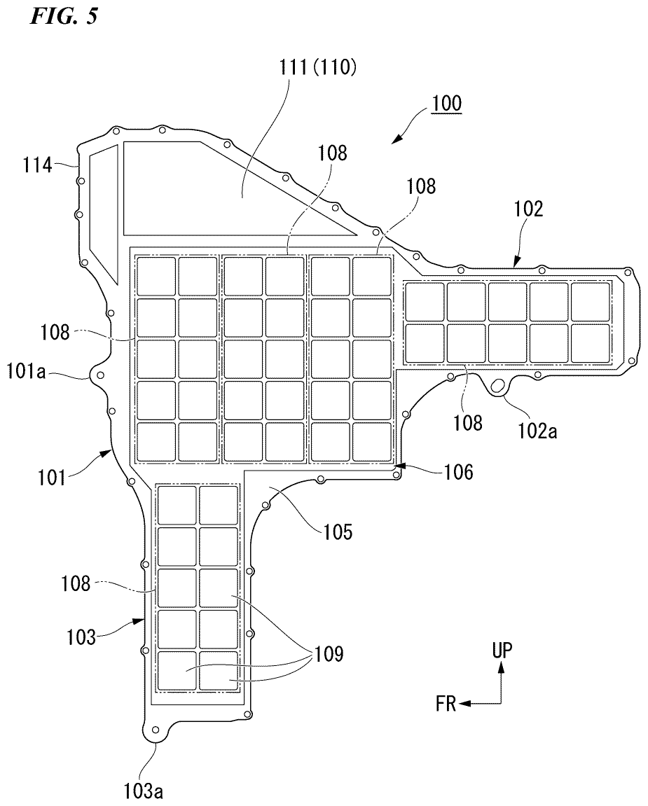

A rear fender 43r extends rearward on a rear side of the seat 9. The rear fender 43r is disposed above the rear wheel 3 to be spaced apart from the rear wheel 3. Reference number 43f in the drawing indicates a front fender disposed above the front wheel 2 to be spaced apart from the front wheel 2, and is supported by the bottom bridge 12. A top cover 44 is disposed on a front side of the seat 9 between upper end portions of front-rear intermediate portions of the pair of front side cowls 41. The top cover 44 covers an upper protrusion portion 110 of the battery unit 100 (see FIGS. 4 and 5) from above.

The rear wheel suspension system 7 includes: a swing arm 30, which pivotally supports the rear wheel 3 at a rear end portion; a link mechanism 31, which couples a front portion of the swing arm 30 with the lower cross member 23; and a rear cushion 32, which extends between the link mechanism 31 and the cross member 22.

The swing arm 30 is disposed below a rear part of the vehicle body, and extends in the front-rear direction. A front end portion of the swing arm 30 is supported to be swingable up and down by the pair of pivot frames 18 via the pivot shaft 33.

The link mechanism 31 includes a pair of left and right link arms 34 and a link member 35. The pair of link arms 34 are disposed below a front portion of the swing arm 30 in a side view, and extends in the front-rear direction. A front end portion of the link arm 34 is rotatably coupled with the link support bracket 23a of the lower cross member 23 via a shaft along the vehicle width direction. A rear end portion of the link arm 34 is rotatably coupled with the link member 35 via a shaft along the vehicle width direction.

The link member 35 is formed in a substantially triangular shape in a side view. A top portion on an upper side of the link member 35 is rotatably coupled with a link coupling portion in a front-rear intermediate portion of the swing arm 30 via a shaft along the vehicle width direction. A top portion on a lower side of the link member 35 is rotatably coupled with a rear end portion of the link arm 34 via a shaft along the vehicle width direction. A top portion on a front side of the link member 35 is rotatably coupled with a lower end portion of the rear cushion 32 via a shaft along the vehicle width direction.

The rear cushion 32 is provided on an inner side in the vehicle width direction (for example, on the vehicle width center CL) in the rear part of the vehicle body. The rear cushion 32 is formed in a cylindrical shape in which a compression coil spring is disposed on the outer circumference of a damper cylinder, and is disposed in an attitude in which the axial direction is inclined forward with respect to the vertical direction. An upper end portion of the rear cushion 32 is rotatably coupled with the cushion support bracket 22a of the cross member 22 via a shaft along the vehicle width direction. A lower end portion of the rear cushion 32 is rotatably coupled with the top portion on the front side of the link member 35 via a shaft along the vehicle width direction. In the embodiment, a constitution in which the rear cushion 32 is provided as a single part on the inner side in the vehicle width direction is exemplified, without being limited to this constitution. For example, another constitution such as a constitution in which a pair of left and right rear cushions 32 are provided between a rear portion of the swing arm 30 and the seat frame may be employed.

The power unit 8 includes: the motor 50 for driving the vehicle; a speed reduction gear (not illustrated) that decelerates output of the motor 50; an output shaft 70, which outputs dynamic power of the motor 50 that has been decelerated by the speed reduction gear; a power control unit (PCU) 130 for controlling the motor 50; and a housing 80, which houses a drive unit, such as the motor 50 and the speed reduction gear, and the PCU 130.

The power unit 8 is constituted as an integrated unit including the motor 50, the speed reduction gear, the output shaft 70, the PCU 130, and the housing 80. The PCU 130 is disposed below the motor 50. The housing 80 forms an outer shape of the power unit 8. The power unit 8 can be cooled by a water-cooling system including the radiator 91.

The motor 50 is disposed with its rotation axis direction along the vehicle width direction. The motor 50 is housed in a motor case 54, which is formed in an upper part of the housing 80. The speed reduction gear of a gear type is disposed on one of the left and right sides of the motor 50.

The output shaft 70 is disposed in a rear lower portion of the motor case 54. The output shaft 70 extends in the vehicle width direction, and a left end portion protrudes to the outside of the housing 80. The left end portion of the output shaft 70 and the rear wheel 3 are interlocked via a chain-type transmission mechanism 77. This enables the output of the motor 50 to be transmitted to the rear wheel 3.

The PCU 130 is a control device including a power drive unit (PDU) that is a motor driver, an electric control unit (ECU) that controls the PDU, and the like. The PDU includes an inverter, and converts electric current supplied from the battery unit 100 from direct current into alternating current, and then supplies the converted current to the motor 50. The PCU 130 is housed in a PCU case 81 of the housing 80.

In addition to the motor case 54, the housing 80 includes the PCU case 81, which houses the PCU 130. The PCU case 81 is disposed below the motor case 54. The PCU case 81 houses the PCU 130 in its inside. The front portion of the PCU case 81 protrudes to a front side relative to a front end portion of the motor case 54.

The power unit 8 (housing 80) is supported by the vehicle body frame 5 via a plurality of fixing portions (including rubber mounts). The power unit 8 is disposed on a front side (on an inner circumferential side) of the pivot frame 18, which is curved in the arc shape convex rearward in a side view. The power unit 8 is disposed above the lower frame 20. The power unit 8 is disposed below a rear lower end portion of the main frame 17 in a side view.

In the power unit 8, an upper portion (the motor case 54) is disposed on a rear side of the down frame 19 to be spaced apart from the down frame 19, and a lower portion (the PCU case 81) extends to near a lower end portion of the down frame 19. A lower part of the PCU case 81 is covered with an undercover 27, which is attached to the lower frame 20.

FIG. 4 is a perspective view of the battery unit 100, and FIG. 5 is a left side view illustrating the inside of the battery unit 100.

As illustrated in FIGS. 1 to 5, the battery unit 100 is formed in a substantially letter L shape in a side view, and is disposed from a front side to an upper side of the power unit 8. The battery unit 100 has a constant left-right width as a whole, and is disposed to be accommodated between inner side surfaces in the vehicle width direction of the left and right main frames 17 in a plan view. The battery unit 100 includes: a central portion (main portion) 101, which has a substantially square shape in a side view, and which is disposed in a position that overlaps the main frame 17; a rearward extending portion 102, which extends rearward from a rear end of the central portion 101; and a downward extending portion 103, which extends downward from a lower end of the central portion 101.

The central portion 101 is disposed in such a manner that a rear upper portion protrudes above the main frames 17 and a front lower portion also protrudes below the main frames 17 in a side view. A portion, which protrudes upward from the main frame 17, of the central portion 101 is covered with a rear portion of the front side cowl 41 from an outer side in the vehicle width direction. On an outer side in the vehicle width direction of the central portion 101, the main frames 17 are disposed to traverse obliquely. A front end portion of the central portion 101 is supported on an up-down intermediate portion of the down frame 19 via a first mount bracket 45. Reference number 101a in the drawing indicates a first mount portion included in the front end portion of the central portion 101.

The rearward extending portion 102 extends rearward between an upper end portion of the rear cushion 32 and a lower surface of the seat 9 in the up-down direction. The rearward extending portion 102 extends rearward to a position that overlaps the front-rear intermediate portion of the seat rail 24 in a side view. The seat receiving bracket 28 is formed in a letter U shape to straddle the rearward extending portion 102 to the left and the right from above. A lower end portion of the rearward extending portion 102 is supported by the cross member 22 via a second mount bracket 46. The second mount bracket 46 is integrally formed with, for example, the cushion support bracket 22a. Reference number 102a in the drawing indicates a second mount portion included in the lower end portion of the rearward extending portion 102.

A 12 V battery 29 for auxiliary equipment is disposed on a further rear side of the rearward extending portion 102. The 12 V battery 29 is supported by a rear portion of the seat frame. Reference number 43i in the drawing indicates a rear inner fender that is supported by the support rail 25 and that suppresses scattering up by the rear wheel 3.

The downward extending portion 103 extends downward between a lower portion of the down frame 19 and the motor case 54 of the power unit 8 in the front-rear direction. The downward extending portion 103 extends to near an upper surface of the PCU case 81. A lower end portion of the downward extending portion 103 is supported by front end portions of the left and right lower frames 20 via a third mount bracket 47. Reference number 103a in the drawing indicates a third mount portion included in the lower end portion of the downward extending portion 103.

The battery unit 100 includes: a center plate 105, which is positioned on a vehicle width center CL; a pair of left and right battery assemblies 106, which are respectively disposed on the left and right sides of the center plate 105; and a pair of left and right battery covers 107, which respectively cover the left and right battery assemblies 106. The battery unit 100 is provided to be left-right symmetric as a whole with the vehicle width center CL as a symmetric axis. Provision of the battery unit 100, which is a heavy object, to be left-right symmetric suppresses the influence of the vehicle weight on the left-right balance.

Each battery assembly 106 is formed by combining a plurality of battery modules 108. Each battery module 108 has a substantially rectangular parallelepiped shape that is long in one direction, and is disposed with its length direction along the front-rear direction or the up-down direction. Each battery module 108 is formed by a plurality of battery cells 109 to be arranged vertically and horizontally. The respective battery cells 109 and battery modules 108 are disposed with their positions in the vehicle width direction aligned with each other.

Each battery module 108 has a thin and long outer shape in one direction, so that it can be easily disposed even in a small space. The shape of the battery unit 100 is easily formed to be suitable for an empty space of the vehicle body, by rearranging the arrangement of the plurality of battery modules 108 to change the overall outer shape. By increasing the degree of freedom in the shape of the battery unit 100, which is a heavy object, and increasing the degree of freedom in the arrangement in an empty space of the vehicle body, the influence on the center of gravity of the vehicle body can be suppressed.

The central portion 101 having a square shape in a side view is formed by, for example, disposing three battery modules 108 with their length directions oriented in the up-down direction and disposing the three battery modules 108 side by side in the front-rear direction. The rearward extending portion 102 having a rectangular shape in a side view is formed by disposing one battery module 108 with its length direction oriented in the front-rear direction. The downward extending portion 103 having a rectangular shape in a side view is formed by disposing one battery module 108 with its length direction oriented in the up-down direction.

In an upper end portion of the battery unit 100, the upper protrusion portion 110, which accommodates electric component parts such as contactors, is provided. The upper protrusion portion 110 protrudes upward relative to the main frame 17 in a side view, and is covered with the top cover 44 from above. The upper protrusion portion 110 includes a plate extension portion 111, in which an upper end portion of the center plate 105 is extended upward relative to upper ends of the battery assemblies 106. Electric component parts such as contactors are attached to both left and right sides of the plate extension portion 111. The upper end portions of the left and right battery covers 107 respectively include cover extension portions 112, which extend upward relative to the upper ends of the battery assemblies 106, so as to conform to the plate extension portion 111. The left and right cover extension portions 112 cover the plate extension portion 111 from the outside on the left and the right to suppress the electric component parts such as contactors from being exposed to the outside of the vehicle.

Rear portions of the plate extension portion 111 and the left and right cover extension portions 112 are positioned below the front portion, which is inclined upward, of the seat 9. Rear upper portions of the plate extension portion 111 and the left and right cover extension portions 112 are formed in a forward and upward inclined shape in a side view so as to conform to the inclination of the front portion of the seat 9. Outer side portions in the vehicle width direction of the left and right cover extension portions 112 are each formed in a chamfered shape that is inclined to be positioned downward toward the outer side in the vehicle width direction. This enables suppression of bulkiness of the upper protrusion portion 110, and the top cover 44 has a compact shape with roundness.

In a front end portion of the battery unit 100, a cable connection portion 114, which protrudes forward from the upper protrusion portion 110 and a front end portion on an upper side of the central portion 101. One end of a high-voltage cable (a positive electrode cable and a negative electrode cable) that extends from the PCU 130 is connected with the cable connection portion 114, and one end of a low-voltage cable that extends from the 12 V battery 29 is also connected with the cable connection portion 114. A drive current is supplied from the battery unit 100 to the PCU 130 through the high-voltage cable, and a drive current is also supplied from the 12 V battery 29 to an electric component such as a contactor through the low-voltage cable.

### <Frame Structure>

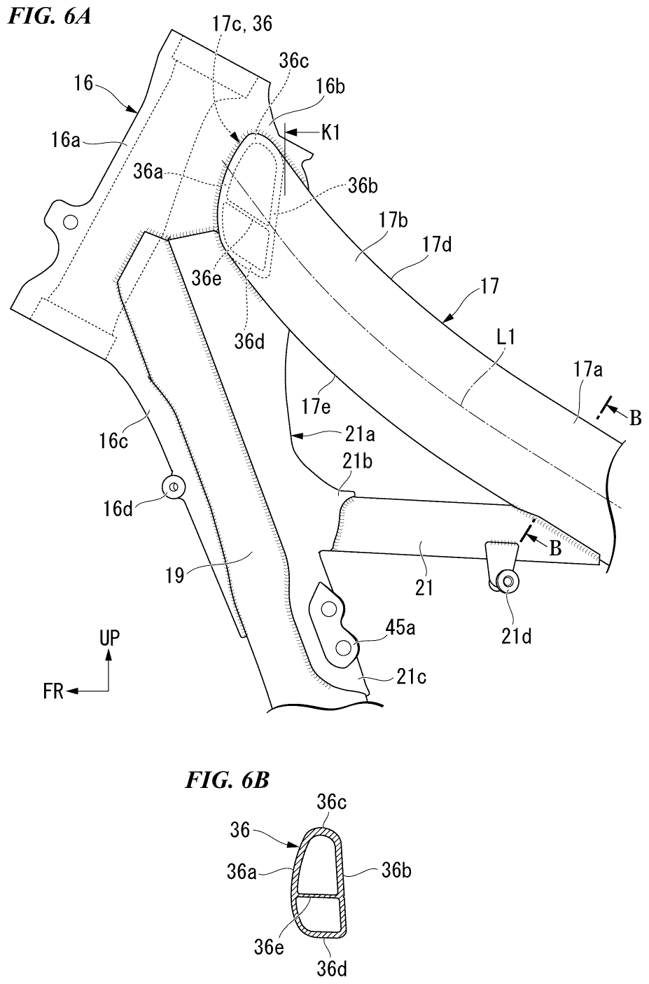

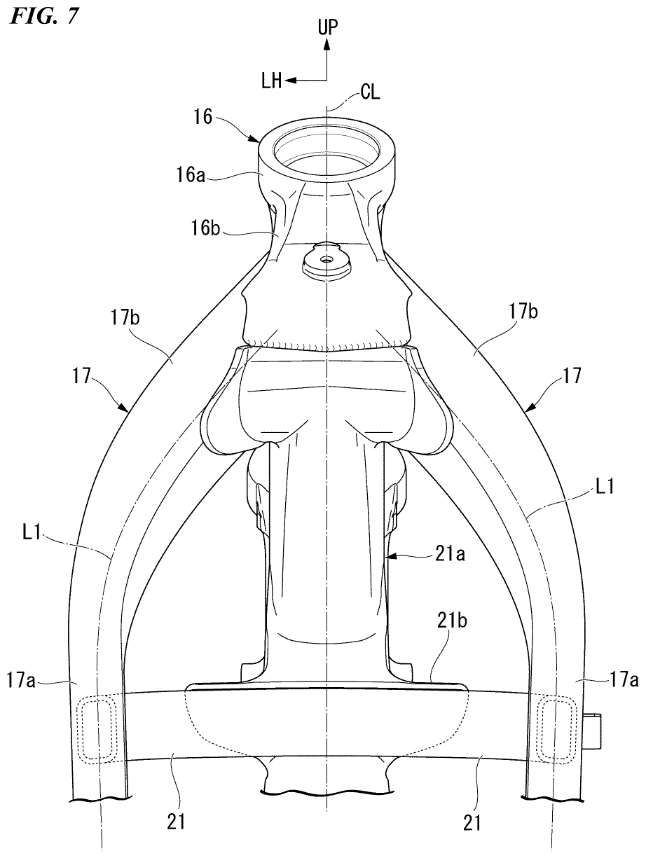

FIG. 6A is a left side view of the front portion of the vehicle body frame 5 of the electric motorcycle 1, FIG. 6B is a cross-sectional view taken along line B-B of FIG. 6A, and FIG. 7 is a rear view of the front portion of the vehicle body frame 5.

As illustrated in FIGS. 6A, 6B, and 7, the main frame 17 includes an extending portion 17a extending linearly along the vehicle front-rear direction in a plan view (see FIG. 3, FIG. 7 is viewed in the front-back direction), and a front curved portion 17b extending from a front end portion of the extending portion 17a so as to be curved inward in the vehicle width direction in the plan view (as viewed in the front-rear direction). The front curved portion 17b is smoothly curved without having a bending point so as to be gradually inclined toward the center in the vehicle width direction in a plan view. In the embodiment, the main frame 17 is constituted by a single extruded material, and forms an integrated upper frame. When the main frame 17 is constituted by a plurality of members, a member located at the uppermost position and extending between the head pipe 16 and the pivot frame 18 is the upper frame.

The front curved portion 17b is provided in front of the front-rear central portion of the main frame 17. The front curved portion 17b is joined to the rear portion of the head pipe 16 outside in the vehicle width direction by welding with a front end portion 17c (which is also a front end portion of the main frame 17) abutting on the rear portion from an oblique direction. The front curved portion 17b extends from the front end portion of the extending portion 17a so as to curve upward in a side view. Accordingly, the extending portion 17a of the main frame 17 is in a mode of being displaced downward relative to the head pipe 16. The front curved portion 17b is smoothly curved without having a bending point so as to be gradually inclined upward toward the head pipe 16 in the side view.

The head pipe 16 according to the embodiment includes a cylindrical head pipe body 16a through which the stem pipe is inserted, and a rearward protrusion portion 16b projecting rearward from an upper rear side of the head pipe body 16a, the rearward protrusion portion 16b being capable of joining the front end portions 17c of the left and right main frames 17 to left and right side surfaces. The head pipe 16 is provided therebehind with a gusset bracket 21a extending downward and rearward so as to be continuous with a lower rear side of the rearward protrusion portion 16b. The gusset bracket 21a extends downward and rearward along a rear surface of an upper portion of the down frame 19, passes through a front position of the gusset pipe 21, and extends to a periphery of a first fastening portion 45a for fastening the first mount bracket 45.

The gusset bracket 21a includes a gusset connection portion 21b that connects front end portions of the gusset pipe 21, and a fastening reinforcement portion 21c that covers the periphery of the first fastening portion 45a of the down frame 19. In the gusset bracket 21a, an upper end portion is joined to the head pipe body 16a and the rearward protrusion portion 16b by welding, and left and right sides of a front edge portion are joined to left and right sides of the upper portion of the down frame 19 by welding. The front end portion 17c of the main frame 17 abuts and is joined by welding across left and right side surfaces of an upper portion of the gusset bracket 21a and left and right side surfaces of the rearward protrusion portion 16b. A front gusset 16c extending downward and rearward from a lower end portion of the head pipe 16 is disposed on a front surface side of an upper portion of the down frame 19. The front gusset 16c is connected by welding from the front surface to left and right side surfaces in the upper portion of the down frame 19.

Referring to FIGS. 3 and 7, the front end portions of the gusset pipe 21 are curved inward in the vehicle width direction and are integrally connected to each other. The gusset pipe 21 of the embodiment is constituted by a single steel pipe formed in a U shape opened rearward in a plan view. Inner sides in the vehicle width direction of the front end portions of the gusset pipe 21 are connected to the gusset connection portion 21b of the gusset bracket 21a.

Referring to FIGS. 3 and 6A, the gusset pipe 21 is fixedly provided with a stay rear attachment portion 21d to which rear portions of left and right radiator stays 92 that support the radiator 91 are attached. The stay rear attachment portion 21d is provided asymmetrically, for example, but may be provided symmetrically. The front gusset 16c has left and right side portions fixedly provided with a stay front attachment portion 16d for attaching front portions of the left and right radiator stays 92. The stay front attachment portion 16d is provided, for example, symmetrically, but may be provided asymmetrically. The radiator stay 92 is attached to the vehicle body frame 5 regardless of the presence or absence of the radiator 91, and functions as a support member of the left and right front side cowls 41 (radiator shrouds). The radiator stay 92 is provided, for example, asymmetrically, but may be provided symmetrically.

The radiator shroud (front side cowl 41) is provided so as to straddle the extending portion 17a of the main frame 17 from a rear upper side to a front lower side in a side view. In the embodiment, by displacing the extending portion 17a that the radiator shroud needs to straddle downward, the upper end height of the radiator shroud is lowered to shorten a vertical dimension of the entire radiator shroud.

When the front end portion 17c of the main frame 17 is connected to the rearward protrusion portion 16b of the head pipe 16, the head pipe body 16a is relatively displaced forward of the front end portion 17c of the main frame 17. This contributes to improvement in weight balance when the battery unit 100 as a heavy object is mounted on the vehicle body frame 5. The down frame 19 is curved forward in a side view at the up-down intermediate portions, and has an upper end position following the head pipe body 16a displaced forward.

Referring to FIG. 2, in a state where the battery unit 100 is mounted on the vehicle body frame 5, the main frame 17 is disposed outside a central portion 101 having a substantially square shape in the side view in the vehicle width direction. The main frame 17 is disposed so as to traverse diagonally from a front upper end to a rear lower end of the central portion 101 in the side view. Reference numeral P1 in the drawing indicates a central position of the outer shape of the central portion 101 in the side view. The main frame 17 is disposed so as to overlap with the center position P1 of the central portion 101 in the side view.

Referring to FIGS. 6A and 6B, the extending portion 17a and the front curved portion 17b of the main frame 17 continuously have a hollow cross-sectional shape 36 that is long in the vertical direction. The cross-sectional shape 36 includes an outer wall portion 36a that forms an outer wall in the vehicle width direction, an inner wall portion 36b that forms an inner wall in the vehicle width direction, an upper end wall portion 36c that forms a wall of an upper end portion, a lower end wall portion 36d that forms a wall of a lower end portion, and a middle wall portion 36e that connects the outer wall portion 36a and the inner wall portion 36b at an up-down intermediate portion of the cross-sectional shape 36.

The outer wall portion 36a is formed in a curved shape protruding outward in the vehicle width direction in a cross-sectional view. The inner wall portion 36b is formed in a linear shape extending over upper and lower ends of the cross-sectional shape 36 in the cross-sectional view. The inner wall portion 36b forms a flat inner wall facing a space (opening for inserting and removing the battery unit 100) between the left and right main frames 17 in a plan view. Reference numeral K1 in FIG. 6A denotes a front end position defined by a rear end position of the cross-sectional shape 36 in the front end portion 17c of the main frame 17 in the space.

Hereinafter, a longitudinal direction extending over the upper and lower ends of the cross-sectional shape 36 is referred to as a cross-sectional longitudinal direction. The inner wall portion 36b of the cross-sectional shape 36 is formed along the cross-sectional longitudinal direction.

The upper and lower edge portions 17d and 17e extending over the extending portion 17a and the front curved portion 17b of the main frame 17 are formed so that the upper and lower end wall portions 36c and 36d having the cross-sectional shape 36 extend in an extending direction of the main frame 17. A line L1 in the drawing indicates a virtual reference line passing through a defined center position of the cross-sectional shape 36 of the main frame 17 and extending in the extending direction. The cross-sectional shape 36 extends along the virtual reference line L1 to continuously form the extending portion 17a and the front curved portion 17b of the main frame 17.

The extending portion 17a is formed so that an inner wall is along a vehicle side surface (plane orthogonal to the vehicle width direction), thereby making it easy to ensure a lateral width of the space between the left and right main frames 17. As the front curved portion 17b is positioned closer to the head pipe 16 side than the extending portion 17a side, the cross-sectional shape 36 is rotated about the lower edge portion 17e side, and the upper edge portion 17d side is positioned closer to the front side (the upper edge portion 17d side is displaced forward). That is, the front curved portion 17b is twisted so as to rotate the cross-sectional shape 36.

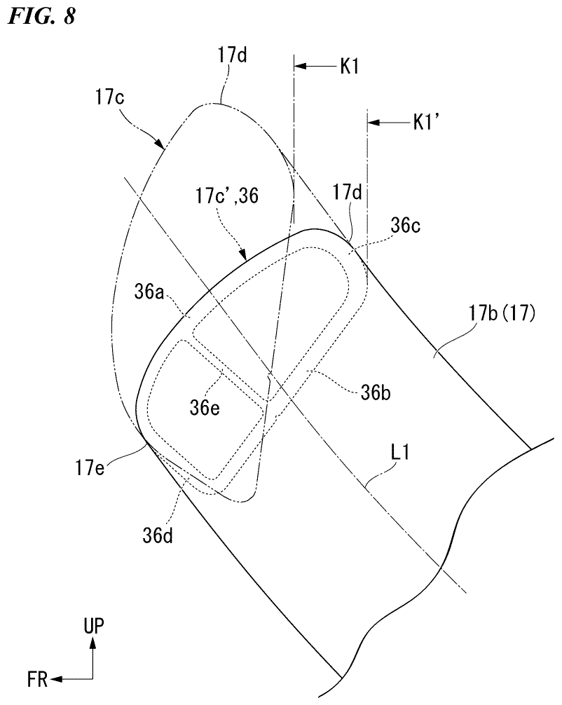

FIG. 8 illustrates a front end portion 17c′ of the front curved portion 17b when the above-described twisting is not applied. When the front curved portion 17b of the main frame 17 extending forward and upward is curved inward in the vehicle width direction, the inner wall portion 36b having the cross-sectional shape 36 is inclined downward. In this case, since the upper edge portion 17d side protrudes rearward (space side between the left and right main frames 17) with respect to the lower edge portion 17e side of the cross-sectional shape 36, a front end position K1′ of the space between the left and right main frames 17 retracts from the front end position K1 when the front curved portion 17b is twisted.

On the other hand, as illustrated in FIG. 6A, the front curved portion 17b of the embodiment is twisted so that the upper edge portion 17c side is positioned forward with the lower edge portion 17e side as the center, thereby suppressing the upper edge portion 17d side from protruding to the space side between the left and right main frames 17. In the example of FIG. 6A, the front curved portion 17b is twisted to such an extent that the inner wall portion 36b of the cross-sectional shape 36 slightly inclines backward with respect to the vertical direction. Thus, while ensuring rigidity by suppressing excessive deformation of the front curved portion 17b, protrusion of the upper edge portion 17d side of the cross-sectional shape 36 toward the space between the left and right main frames 17 is suppressed as much as possible.

As described above, the electric motorcycle 1 according to the above embodiment is a saddle-type electric vehicle including: the head pipe 16 supporting the steered wheel (front wheel 2); the pair of left and right main frames 17 extending rearward from the head pipe 16 so as to branch to the left and right; the pair of left and right pivot frames 18 extending downward from the rear end portions of the pair of left and right main frames 17; the cross member 22 that connects the upper portions of the pair of left and right pivot frames 18 to each other; and the battery unit 100 that is disposed between the left and right main frames 17 behind the head pipe 16 and stores electric power for driving the vehicle, in which each main frame 17 includes the extending portion 17a extending along the vehicle front-rear direction in a plan view and the front curved portion 17b extending forward from the extending portion 17a so as to curve inward in the vehicle width direction in the plan view, and having the front end portion 17c connected to the head pipe 16, and the front curved portion 17b extends forward of the extending portion 17a so as to curve upward in a side view.

With this constitution, the front curved portion 17b of each main frame 17 curved inward in the vehicle width direction in a plan view is curved upward also in the side view. Thus, the position of each main frame 17 is lowered downward with respect to the head pipe 16 as a whole, and the range of the battery unit 100 protruding upward from each main frame 17 increases. Then, even in the constitution in which the battery unit 100 is inserted and removed from above between the left and right main frames 17, the upper portion of the battery unit 100 is easily held, and the range of the battery unit 100 passing between the left and right main frames 17 is reduced. Thus, the workability of inserting and removing the battery unit 100 can be improved without affecting the capacity of the battery unit 100. As the position of the main frame 17 is lowered, the degree of freedom in arrangement of the legs of the occupant is improved. For example, when the saddle-type electric vehicle is an off-road vehicle, the main frame 17 can be made less likely to be an obstacle even at the time of cornering in which the leg on the turning side is extended forward.

In the above electric motorcycle 1, the front curved portion 17b has a cross-sectional shape 36 that is long in an up-down direction, and the front curved portion 17b is formed by being twisted so that the cross-sectional longitudinal direction, which is the longitudinal direction of the cross-sectional shape 36, approaches the vertical direction in the side view as approaching the head pipe side from the extending portion 17a side. That is, the front curved portion 17b is formed by being twisted so that the cross-sectional longitudinal direction of the front end portion 17c on the head pipe 16 side approaches the vertical direction in the side view.

With this constitution, the front curved portion 17b is formed by being twisted so that the cross-sectional longitudinal direction approaches the vertical direction as the front curved portion 17b approaches the head pipe 16, whereby the cross-sectional shape 36 of the front curved portion 17b can be prevented from falling backward and narrowing the space between the left and right main frames 17 near the head pipe 16.

When the front curved portion 17b extends along the virtual reference line L1 with a substantially constant cross section and the cross-sectional shape 36 of the front curved portion 17b is inclined so as to follow the curve of the virtual reference line L1, the cross-sectional shape 36 of the front curved portion 17b is inclined backward with respect to the vertical direction and projects into the space between the left and right main frames 17 as illustrated in FIG. 8. Therefore, the cross-sectional shape 36 of the front curved portion 17b retracts the front end position K1 of an inter-frame opening (opening for inserting and removing the battery unit 100) between the left and right main frames 17.

On the other hand, the front curved portion 17b is formed by being twisted so that the cross-sectional longitudinal direction approaches the vertical direction as approaching the head pipe 16, whereby the inner wall near the front end of the front curved portion 17b can be made along the insertion and removal direction of the battery unit 100. Thus, a clearance at the time of insertion and removal of the battery unit 100 can be easily ensured near the front end of the front curved portion 17b, and the insertion and removal workability of the battery unit 100 can be improved without affecting the outer shape (eventually, the capacity) of the battery unit 100.

Furthermore, in the above electric motorcycle 1, the battery unit 100 includes a rectangular parallelepiped box portion (central portion 101) overlapping the main frame 17 in a side view, and the central portion 101 protrudes upward and downward of the main frame 17 in the side view, and the main frame 17 is disposed outside in the vehicle width direction at a center position of the central portion 101 in the side view.

With this constitution, by disposing the main frame 17 on the outer side in the vehicle width direction of the center position of the rectangular parallelepiped central portion 101, the vicinity of the center of the box-shaped object having relatively low strength can be protected by the main frame 17 from the outer side in the vehicle width direction. Although hot air tends to be confined upward inside the battery unit 100, since the upper portion of the central portion 101 protrudes upward from the main frame 17, the main frame 17 does not hinder heat dissipation from the upper portion of the central portion 101, and cooling performance of the battery unit 100 can be improved.

The present invention is not limited to the above embodiment, and for example, the main frame of the embodiment has a flat cross-sectional shape with the longitudinal direction oriented in the up-down direction, without being limited to this constitution. For example, the main frame only needs to curve inward in the vehicle width direction in plan view and curve upward in the side view. For example, the main frame may have a cross-sectional shape different from that of the embodiment, such as a circular cross-section. The pivot frames are not limited to one provided as a pair on the left and right, and may be provided integrally on the left and right.

The constitution of the present embodiment may be applied to a saddle-type electric vehicle other than a two-wheeled vehicle. The saddle-type vehicle includes general vehicles the vehicle body of which a driver straddles, and includes not only motorcycles (including motorized bicycles and scooter type vehicles) but also three-wheeled vehicles (including, in addition to a vehicle including one front wheel and two rear wheels, a vehicle including two front wheels and one rear wheel) or four-wheeled vehicles (such as four-wheeled buggies).

The constitution in the above embodiments is an example of the present invention, and various modifications can be made without departing from the gist of the present invention, such as replacing a component element in an embodiment with a known component element.

What is claimed is:

1. A saddle-type electric vehicle comprising:
a head pipe supporting a steered wheel;
a pair of left and right upper frames extending rearward from the head pipe so as to branch leftward and rightward; and
a vehicle driving storage battery disposed between the pair of left and right upper frames behind the head pipe, wherein
each of the upper frames includes
an extending portion extending along a vehicle front-rear direction in a plan view, and
a front curved portion extending forward of the extending portion so as to curve inward in a vehicle width direction in the plan view, and having a front end portion connected to the head pipe, and
the front curved portion extends forward of the extending portion so as to curve upward in a side view.

2. The saddle-type electric vehicle according to claim 1, wherein
the front curved portion has a cross-sectional shape that is long in an up-down direction, and the front curved portion is formed by being twisted so that a cross-sectional longitudinal direction, which is a longitudinal direction of the cross-sectional shape, approaches a vertical direction in the side view as approaching the head pipe side from the extending portion side.

3. The saddle-type electric vehicle according to claim 1, wherein
the storage battery includes a rectangular parallelepiped box portion overlapping each of the upper frames in the side view, and the box portion protrudes upward and downward of each of the upper frames in the side view, and each of the upper frames is disposed outside in the vehicle width direction at a center position of the box portion in the side view.

4. The saddle-type electric vehicle according to claim 1, wherein
the front curved portion of the upper frame on a front side of a front-rear center is gradually inclined upward in the side view, and
the front curved portion is gradually inclined toward a center in the vehicle width direction in a top view.

5. The saddle-type electric vehicle according to claim 1, wherein
a shroud is provided so as to straddle the upper frame from a front side to a rear side in the side view.
